(19) United States
(12) Patent Application Publication
(10) Pub. No.: US 2018/0115600 A1
(43) Pub. Date: Apr. 26, 2018

(54) SYSTEM AND METHOD FOR HEALTH MONITORING AND TASK AGILITY WITHIN NETWORK ENVIRONMENTS

(71) Applicant: American Express Travel Related Services Company, Inc., New York, NY (US)

(72) Inventors: Rares Ioan Almasan, Phoenix, AZ (US); Rebecca Lyn Henry, Phoenix, AZ (US)

(73) Assignee: American Express Travel Related Services Company, Inc., New York, NY (US)

(21) Appl. No.: 15/334,577

(22) Filed: Oct. 26, 2016

(51) Int. Cl. H04L 29/08; G06F 9/50; H04L 12/24

(52) U.S. Cl. CPC H04L 67/1002; H04L 41/0816; G06F 9/5083

(57) ABSTRACT

Systems and methods for health monitoring and task agility within network environments are provided. The system may comprise a master data controller configured to monitor servers located in an environment level of a network environment. The master data controller may also monitor tasks located on each server. The master data controller may detect a change in a task feature related to the task. The master data controller may also detect a change in an environment feature related to the servers. The master data controller may recalibrate the task in response to the change in the task feature or the change in the environment feature.

### FIELD

The disclosure generally relates to computer networks, and more specifically, to systems and methods for health monitoring and task agility within network environments.

### BACKGROUND

A computer network may comprise various network environments, with each network environment having various environment levels. Each environment level may comprise various servers and/or computer architecture. Business processes may rely on tasks running across various servers depending on server resources and/or data availability. Tasks may need to be relocated from a specific server within a specific environment level to different location (e.g., a different server in a different environment level, or a different server in a different environment level in a different network environment) in order to achieve higher performance and efficiency, avoid system crashes, provide the task with access to new sets of data, and/or the like. Currently, tools may exist to assist in running tasks on a specific server within a specific environment level, but manual intervention may be needed to move the task from the specific server to a different location (e.g., a different server in the same environment level, a different server in a different environment level, or a different server in a different environment level in a different network environment).

### SUMMARY

Systems, methods, and articles of manufacture (collectively, the “system”) for health monitoring and task agility within network environments are disclosed. The system may comprise a master data controller configured to monitor a plurality of servers. Each server may be located within an environment level of a network environment. The master data controller may monitor a task located on a server. The master data controller may detect a change in a task feature, wherein the task feature is related to the task. The master data controller may detect a change in an environment feature. The environment feature may be related to at least one of the network environment, the environment level, or the servers. The master data controller may recalibrate the task in response to at least one of the change in the task feature or the change in the environment feature.

In various embodiments, the task may comprise at least one subtask. The system master data controller may further recalibrate at least one subtask in response to at least one of the change in the task feature or the change in the environment feature. In various embodiments, the task feature may comprise at least one of a task dependency, a task data source, or a subtask data source. In various embodiments, the environment feature may comprise at least one of a server usage, a server speed, a server resource, a server error rate, or a server configuration.

In various embodiments, the system may further comprise a local data controller in logical communication with the master data controller. The local data controller may monitor the servers and the task. The local data controller may detect at least one of the change in the task feature or the change in the environment feature. The local data controller may recalibrate the tasks in response to at least one of the change in the task feature or the change in the environment feature.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for health monitoring and task agility within network environments, in accordance with various embodiments;

FIG. 2 is a block diagram illustrating various system components of a system for health monitoring and task agility within network environments including local data controllers, in accordance with various embodiments; and

FIG. 3 illustrates a process flow of health monitoring and task agility within network environments, in accordance with various embodiments.

### DETAILED DESCRIPTION

The detailed description of exemplary embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

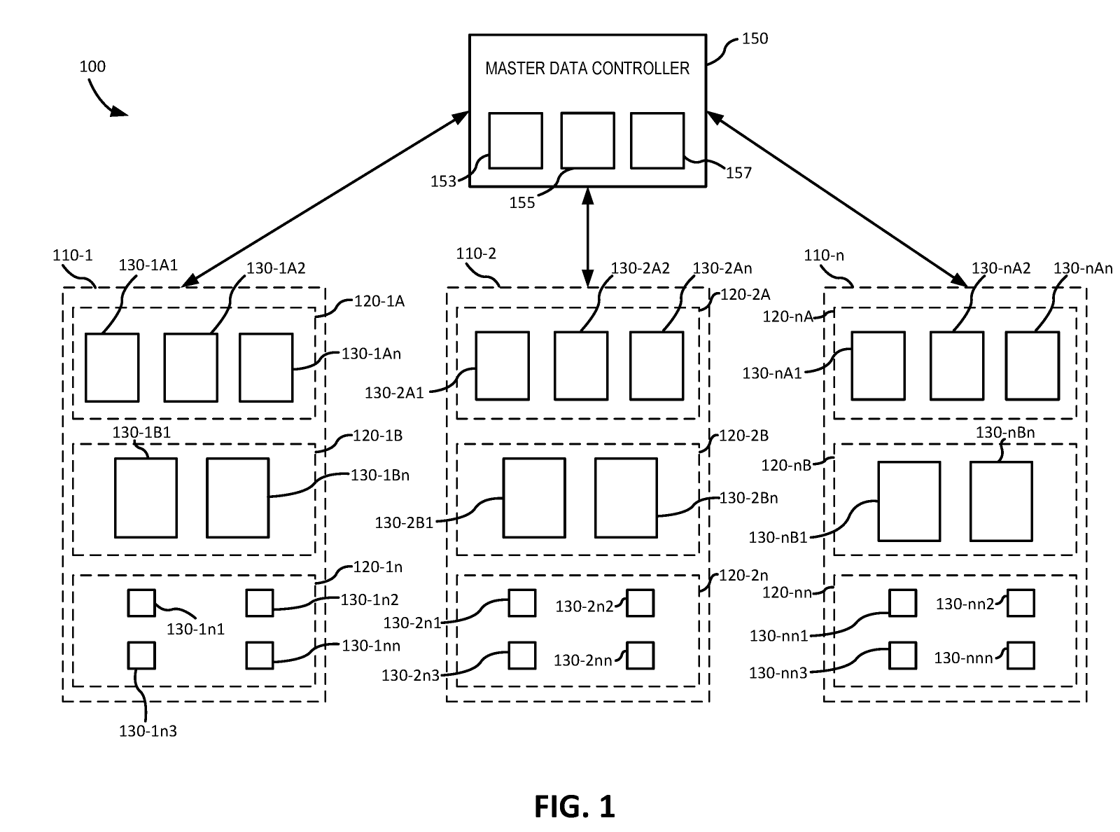

In various embodiments, and with reference to FIG. 1, a system 100 for health monitoring and task agility within network environments is provided. System 100 may comprise various network environments 110, environment levels 120, servers 130, and a master data controller 150, as described herein. In various embodiments, and as discussed further herein, system 100 may at least partially eliminate and/or reduce costs associated with manual intervention typically used in transferring and recalibrating tasks. In that respect, system 100 enables automation of health monitoring and task agility in network environments, allowing tasks to be efficiently recalibrated and transferred from server to server. System 100 may increase efficiency through health monitoring and task agility, thus resulting in the reduction of monetary costs associated with re-executing tasks, delayed delivery of tasks, additional processing caused by inefficient tasks, and/or the like. System 100 may result in reductions to monetary costs associated with the unnecessary operation of system components and hardware, including, for example, server costs, CPU costs, storage costs, memory costs, and/or the like.

In various embodiments, system 100 may comprise any number and configuration of network environments 110 such as, for example, a first network environment 110-1, a second network environment 110-2, and/or any number “n” of network environments 110, such as Nth network environment 110-n. First network environment 110-1, second network environment 110-2, and network environment 110-n may be in communication with and/or operatively coupled to (e.g., in “logical communication” with) master data controller 150. Network environments 110 may comprise any suitable type of network capable of transmitting and/or receiving data such as, for example, an intranet, the internet, and/or the like. In various embodiments, first network environment 110-1, second network environment 110-2, and/or network environment 110-n may comprise portions of the same larger network. In other embodiments, first network environment 110-1, second network environment 110-2, and/or network environment 110-n may comprise discrete networks.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

As used herein, the term “network” includes any cloud, cloud computing system or electronic communications system or method which incorporates hardware and/or software components. Communication among the parties may be accomplished through any suitable communication channels such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network (e.g., network environments 110) via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

As used herein, “transmit” may include sending electronic data from one system component to another over a network connection. Additionally, as used herein, “data” may include encompassing information such as commands, queries, files, data for storage, and/or the like, in digital or any other form.

In various embodiments, each network environment 110 may comprise one or more environment levels 120. Environment levels 120 may comprise sub-networks (e.g., portions of the network environment 110) within, and/or in logical communication with, each network environment 110. Environment levels 120 may comprise any suitable type of network, or sub-network, as described herein such as, for example, an intranet, the internet, and/or the like. In various embodiments, each environment level 120 may also comprise discrete networks in logical communication with the corresponding network environment 110.

In various embodiments, each network environment 110 may comprise any number and configuration of environment levels 120. For example, and in various embodiments, first network environment 110-1 may comprise environment level 120-1A, environment level 120-1B, and/or any other number “n” of environment levels 120, such as an Nth environment level 120-1n; second network environment 110-2 may comprise environment level 120-2A, environment level 120-2B, and/or any other number “n” of environment levels 120, such as an Nth environment level 120-2n; and/or network environment 110-n may comprise environment level 120-nA, environment level 120-nB, and/or any other number “n” of environment levels 120, such as an Nth environment level 120-nn.

In various embodiments, each environment level 120 within a network environment 110 may include one or more servers 130. Servers 130 may comprise any configuration of computer hardware and/or software capable of receiving, processing, and transmitting data, tasks, and/or the like. In that regard, servers 130 may comprise processors, databases (and/or any other suitable storage mechanism), various input and/or output capabilities, network interfaces, and/or the like, along with other suitable system software and hardware components. In various embodiments, each server 130 may also comprise a cluster of servers in logical communication and processing as a single server. In various embodiments, each server 130 may be in logical communication with other servers 130, based on operational requirements such as data dependencies and the like. In that respect, and in various embodiments, each server 130 may not be in logical communication with every server 130.

In various embodiments, each environment level 120 may comprise any number and configuration of servers 130. For example, and in various embodiments, in first network environment 110-1, environment level 120-1A may comprise a first server 130-1A1, a second server 130-1A2, and/or any other number “n” of servers 130, such as an Nth server 130-1An; environment level 120-1B may comprise a first server 130-1B1, and/or any other number “n” of servers 130, such as an Nth server 130-1Bn; and/or environment level 120-1n may comprise a first server 130-1n1, a second server 130-1n2, a third server 130-1n3, and/or any other number “n” of servers 130, such as an Nth server 130-1nn. For example, and in various embodiments, in second network environment 110-2, environment level 120-2A may comprise a first server 130-2A1, a second server 130-2A2, and/or any other number “n” of servers 130, such as an Nth server 130-2An; environment level 120-2B may comprise a first server 130-2B1, and/or any other number “n” of servers 130, such as an Nth server 130-2Bn; and/or environment level 120-2n may comprise a first server 130-2n1, a second server 130-2n2, a third server 130-2n3, and/or any other number “n” of servers 130, such as an Nth server 130-2nn. For example, and in various embodiments, in network environment 110-n, environment level 120-nA may comprise a first server 130-nA1, a second server 130-nA2, and/or any other number “n” of servers 130, such as an Nth server 130-nAn; environment level 120-nB may comprise a first server 130-nB1, and/or any other number “n” of servers 130, such as an Nth server 130-nBn; and/or environment level 120-nn may comprise a first server 130-nn1, a second server 130-nn2, a third server 130-nn3, and/or any other number “n” of servers 130, such as an Nth server 130-nnn.

In various embodiments, servers 130 may be configured to execute a task. The task may comprise processing computer data in system 100 such as, for example, during the creation and/or sending of data, formatting of data, statistical and/or analytical analysis of data, and/or the like. In that regard, the task may comprise any suitable task, event, job, and/or processing of computer data in system 100. In various embodiments, the task may comprise subtasks. For example, where the task comprises analyzing data, a first subtask may comprise retrieving data, a second subtask may comprise analyzing the data, a third subtask may comprise generating an output of the analyzed data, and/or a fourth subtask may comprise transmitted the output of the analyzed data. In that regard, each subtask may be executed across different servers 130. For example, in a task having four subtasks (e.g., a first subtask, a second subtask, a third subtask, and a fourth subtask), the first subtask may be executed on server 130-1n3, the second subtask may be executed on server 130-1B1, the third subtask may be executed on server 130-2A1, and the fourth subtask may be executed on server 130-nB1. In various embodiments, the subtasks may be executed on any suitable combination of servers 130 that are in logical communication with each other.

In various embodiments, system 100 may comprise a master data controller 150. Master data controller 150 may be in logical communication with each network environment 110, each environment level 120 within network environments 110, and/or each server 130 within each environment level 120. Master data controller 150 may be located within a network environment 110 (e.g., within first network environment 110-1, second network environment 110-2, and/or network environment 110-n), or master data controller 150 may be located in a distinct network outside of network environments 110. Master data controller 150 may provide machine learning and predictive analysis capabilities, as discussed further below.

In various embodiments, master data controller 150 may comprise any suitable device, server, processor, and/or the like capable of monitoring tasks, servers, and/or network environments; receive, transmit, and/or analyze tasks; and/or the like. In various embodiments, master data controller 150 may also be computer based, and may comprise a processor, a tangible non-transitory computer-readable memory, and/or a network interface, along with other suitable system software and hardware components, including data sources, database, and/or the like. Instructions stored on the tangible non-transitory memory may allow master data controller 150 to perform various functions, processes, and/or methods, as described herein. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in in re Nuijten to fall outside the scope of patentable subject matter under 35 U.S.C. §101.

In various embodiments, master data controller 150 may comprise various modules. For instance, master data controller 150 may comprise a task monitoring module 153, a server monitoring module 155, and/or a task recalibration module 157. The various modules may facilitate various methods and communication among various system 100 components.

In various embodiments, master data controller 150 may be configured to monitor the tasks running on servers 130. In that regard, and in various embodiments, task monitoring module 153 may monitor the tasks running on servers 130. Master data controller 150, via task monitoring module 153, may monitor the tasks in real time, semi-real time, and/or at any other suitable and/or desired interval. In various embodiments, master data controller 150, via task monitoring module 153, may monitor every task running on each server 130 or may monitor only a subset of tasks and/or subtasks. For example, master data controller 150, via task monitoring module 153, may be configured to monitor only tasks on servers 130 in a particular network environment 110 (e.g., first network environment 110-1), in a particular environment level 120 (e.g., environment level 120-1A), and/or on a particular server 130 (e.g., server 130-1A1). In that respect, master data controller 150 may receive instructions on the tasks to monitor, or may monitor specific tasks based on defined business processes.

In various embodiments, master data controller 150, via task monitoring module 153, may monitor the tasks to detect a change in a task feature. The task feature may comprise any task-related attribute in system 100 that may necessitate a recalibration of the task. The change in the task feature may be caused by a change in business processes, operational factors, and/or the like. For example, the task feature may comprise a task dependency (e.g., a second task may be dependent on a first task completing prior to execution of the second task). A change in the task dependency may require that the second task complete prior to the execution of the first task). The task feature may comprise a task data source. For example a task executing on server 130-1A1 may require data located on server 130-1Bn, 130-2n1, and 130-2B1. A change in the task data source may require data located on server 130-1Bn, 130-2n1, 130-2B1, and 130-nA1. A change in the task data source may also occur in response to a required data element becoming available in a different task data source. The task feature may also comprise a subtask data source (e.g., each subtask for the task may comprise different required task data sources). The change in the task feature may cause a need to recalibrate the task, as changes in system 100 may cause execution of the task to no longer be as efficient and/or possible without error.

In various embodiments, master data controller 150 may also be configured to monitor network environments 110, environment levels 120, and/or servers 130. In that regard, server monitoring module 155 may be configured to monitor servers 130, and/or network environments 110 and environment levels 120. Master data controller 150, via server monitoring module 155, may monitor servers 130 in real time, semi-real time, and/or at any other suitable and/or desired interval. In various embodiments, master data controller 150, via server monitoring module 155, may monitor all servers 130 in system 100, or may monitor only a subset of servers 130. For example, master data controller 150, via server monitoring module 155, may be configured to only monitor servers 130 in a particular network environment (e.g., first network environment 110) or in a particular environment level 120 (e.g., environment level 120-1A).

In various embodiments, master data controller 150, via server monitoring module 155, may monitor servers 130 to detect a change in an environment feature. The environment feature may comprise any environment related event and/or attribute in system 100 that may require a recalibration of the task. For example, the environment feature may comprise a server usage (e.g., a server may be processing at 50%, 60%, and/or the like). A change in server usage may comprise the server reaching a specific level of processing usage, such as for example, 80% or 90%. As a further example, the environment feature may comprise a server speed. The server speed may comprise operating and/or processing speeds of the server, such as internet upload and download speeds, CPU processing speeds, storage read/write speeds, and/or the like. A change in the server speed may result from server component failure, and/or other such similar events. The environment feature may also comprise a server expense such as, for example, a monetary expense to run the server. In that respect, the task may be relocated to a different server based on cost efficiencies. The environment feature may also comprise server resources, such as firewalls, securities, and/or the like. The environment feature may also comprise a server error rate. For example, a change in the server error rate may comprise a defined threshold of acceptable errors, such as a 5% error rate, and/or any other desired error rate. The environment feature may also comprise a server configuration. A change in the server configuration may comprise the addition or removal of a server, upgrades to server components, software installations, and/or the like. For example, a new server may be introduced outside of the initial environment. The environment feature may therefore cause a need to recalibrate the task, as changes in system 100 may cause servers 130, and/or the tasks running on the server, to not run as efficiently.

In various embodiments, master data controller 150 may also be configured to recalibrate the tasks. In that regard, and in various embodiments, task recalibration module 157 may be configured to recalibrate the tasks. Master data controller 150, via task recalibration module 157, may recalibrate the tasks in response to detecting the task features and/or the environment features. In that regard, recalibration of the tasks may be based at least in part on machine learning and predictive analysis to maximize efficiency and economics in system 100. In various embodiments, master data controller 150, via task recalibration module 157, may recalibrate the task by transferring the task, and/or a subtask of the task, to any other suitable server 130 (e.g., a server 130 having necessary logical communications with data sources on other servers 130 that are needed to execute the task). A suitable server 130 may comprise any server 130 that is capable of efficiently executing the task. For example, a task may require data located on other servers in a network environment 110 such as, for example, data located on servers 130-1Bn, 130-2n1, and 130-2B1. In recalibrating the task, master data controller 150, via task recalibration module 157, may locate a server 130 in system 100 that is in logical communication with servers 130-1Bn, 130-2n1, and 130-2B1, such that the task may execute.

In various embodiments, master data controller 150, via task recalibration module 157, may also transfer the task, and/or subtask, to master data controller 150. In that regard, master data controller 150 may receive and execute the task, and/or subtask, as needed. For example, master data controller 150 may execute the task until a server 130 having required resources becomes available, until completion of the task, and/or the like. Master data controller 150, via task recalibration module 157, may then transfer the task, and/or subtask, to a suitable server 130 when available.

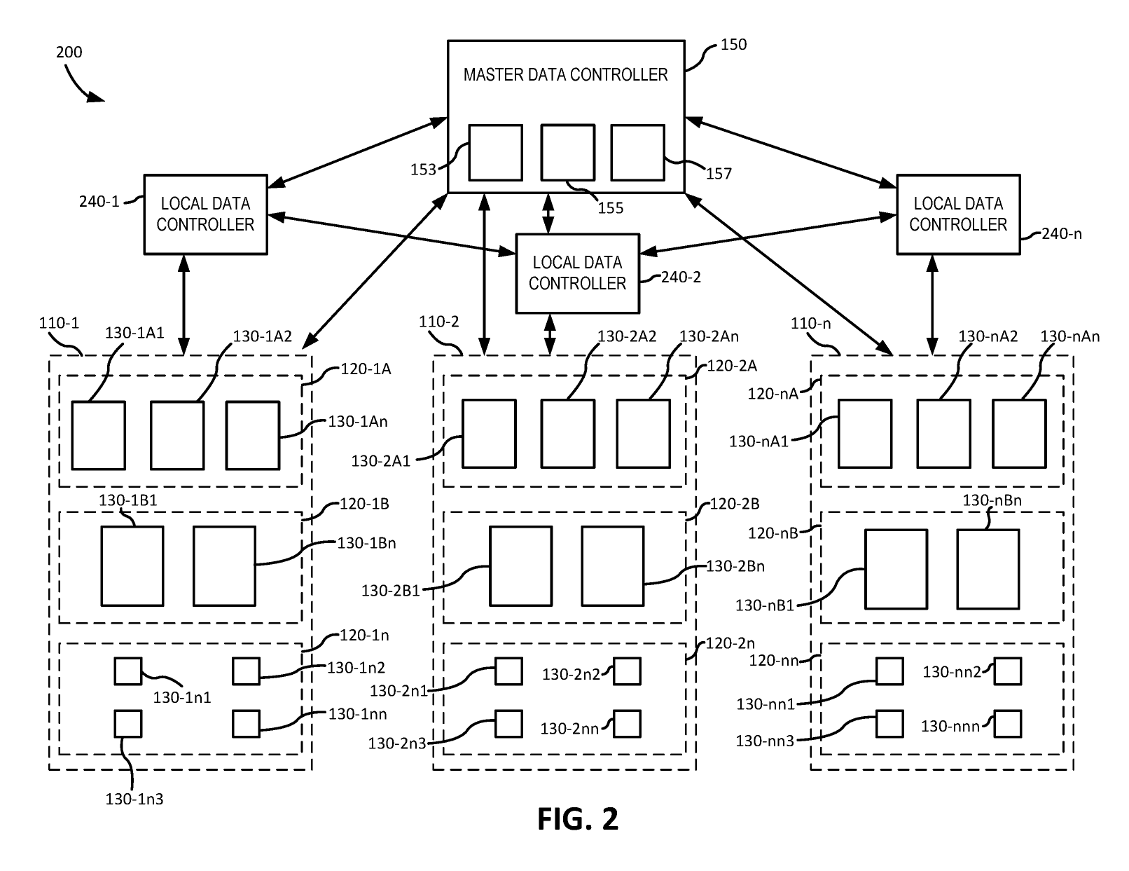

In various embodiments, and with reference to FIG. 2, system 200 may comprise one or more local data controllers 240. In that regard, system 200 may comprise a local data controller 240 for each network environment 110 in system 200. For example, wherein system 200 comprises first network environment 110-1, second network environment 110-2, and network environment 110-n, system may comprise a first local data controller 240-1 in logical communication with first network environment 110-1, a second local data controller 240-2 in logical communication with second network environment 110-2, and/or an Nth local data controller 240-n in logical communication with network environment 110-n. Each local data controller 240 may be located within its corresponding network environment 110. In various embodiments, each local data controller 240 may also be in located in distinct networks separate from its corresponding network environment 110.

In various embodiments, local data controllers 240 may comprise similar attributes and functionalities as master data controller 150, as described in this disclosure. For example, each local data controller 240 may comprise a various modules, such as, a task monitoring module, a server monitoring module, and/or a task recalibration module. Each local data controller 240 may be in logical communication only with its corresponding network environment 110 (e.g., local data controller 240-1 is in logical communication with network environment 110-1), with the environment levels 120 and servers 130 located within that network environment 110, and with master data controller 150. Local data controllers 240 may monitor and recalibrate tasks in its corresponding network environment 110, using the same techniques and features provided by master data controller 150. In that respect, local data controllers 240 may therefore increase efficiencies in system 200, by enabling each local data controller 240 to monitor and recalibrate tasks in a single network environment 110.

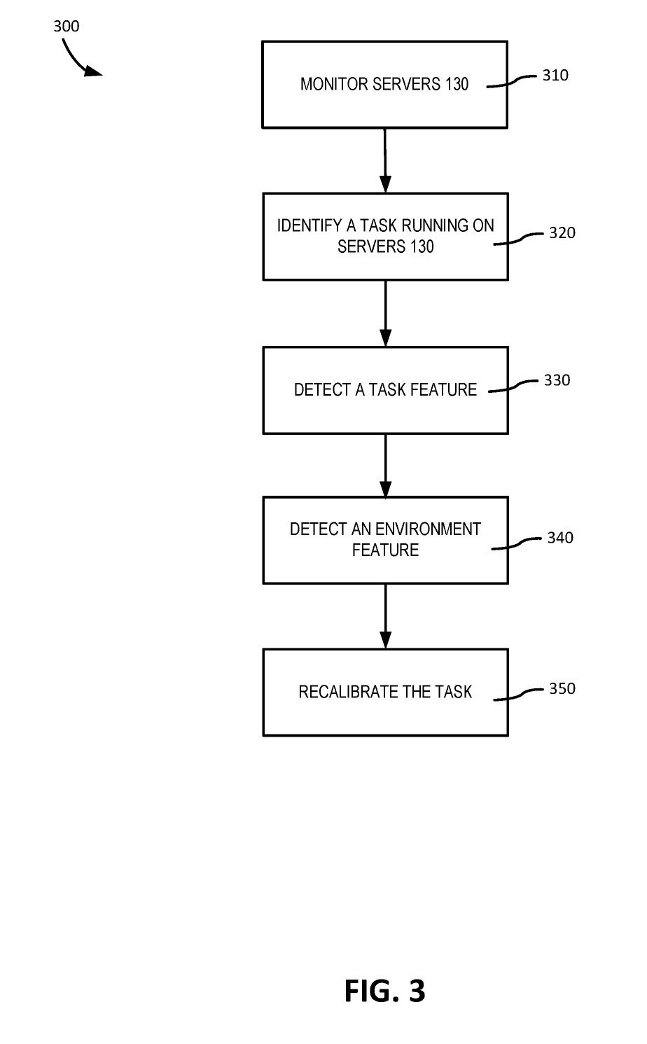

In various embodiments, and with reference to FIG. 3, a method 300 for health monitoring and task agility in network environments is disclosed. Method 300 may comprise monitoring servers 130 (Step 310). In that regard, master data controller 150 may monitor servers 130. Master data controller 150 may be in logical communication with each server 130 in system 100, via each network environment 110 and environment levels 120. Master data controller 150 may communicate with each server 130, or a subset of servers 130, as discussed herein, to monitor the server for tasks, environment features, task features, and/or the like. In various embodiments, and with brief reference to FIG. 2, servers 130 may also be monitored by local data controllers 240. In that respect, each local data controller 240 may monitor each server 130 corresponding to the network environment 110 in logical communication with each local data controllers 240 (e.g., first local data controller 240-1 may monitor servers 130-1A1, 130-1A2, 130-1An, 130-1B1, 130-1Bn, 130-1n1, 130-1n2. 130-1n3, and/or 130-1nn, in network environment 110-1).

In various embodiments, method 300 may comprise identifying a task running on servers 130 (Step 320). Master data controller 150 may be configured to identify the tasks, and/or subtasks, running on servers 130. In that regard, master data controller 150 may identify the tasks, and/or subtasks, while monitoring each server 130 (e.g., during Step 310). In various embodiments, master data controller 150 may identify every task processing and/or executing on servers 130, and may monitor the tasks, and/or subtasks, during processing. In various embodiments, master data controller 150 may also be instructed to monitor specific tasks on each server 130 (e.g., instructed by a user, business process, and/or the like). In various embodiments, and with brief reference to FIG. 2, local data controllers 240 may be configured to monitor the tasks and/or subtasks. In that respect, each local data controller 240 may monitor tasks on servers 130 corresponding to the network environment 110 in logical communication with each local data controllers 240 (e.g., first local data controller 240-1 may monitor tasks processing on servers 130-1A1, 130-1A2, 130-1An, 130-1B1, 130-1Bn, 130-1n1, 130-1n2. 130-1n3, and/or 130-1nn, in network environment 110-1).

In various embodiments, method 300 may comprise detecting a task feature (Step 330). In that regard, master data controller 150 (and/or local data controller 240, with brief reference to FIG. 2) may be configured to detect the task feature. Master data controller 150 may detect the task feature while monitoring the task (e.g., while monitoring the task in Step 320). The task feature may be related to the task. For example, the task feature may comprise any task-related attribute in system 100 that may necessitate a recalibration of the task. The change in the task feature may be caused by a change in business processes, operational factors, and/or the like. For example, the task feature may comprise a task dependency (e.g., a second task may be dependent on a first task completing prior to execution of the second task). A change in the task dependency may require that the second task complete prior to the execution of the first task). The task feature may comprise a task data source. For example a task executing on server 130-1A1 may require data located on server 130-1Bn, 130-2n1, and 130-2B1. A change in the task data source may require data located on server 130-1Bn, 130-2n1, 130-2B1, and 130-nA1. The task feature may also comprise a subtask data source (e.g., each subtask for the task may comprise different required task data sources).

In various embodiments, method 300 may comprise detecting an environment feature (Step 340). Master data controller 150 (and/or local data controller 240, with brief reference to FIG. 2) may be configured to detect the environment feature. Master data controller 150 may detect the environment feature while monitoring servers 130 (e.g., while monitoring servers 130 in Step 310). The environment feature may be related to each server 130. In that respect, the environment feature may comprise any environment related event and/or attribute in system 100 that may require a recalibration of the task. For example, the environment feature may comprise a server usage (e.g., a server may be processing at 50%, 60%, and/or the like). A change in server usage may comprise the server reaching a specific level of processing usage, such as for example, 80% or 90%. As a further example, the environment feature may comprise a server speed. The server speed may comprise operating and/or processing speeds of the server, such as internet upload and download speeds, CPU processing speeds, storage read/write speeds, and/or the like. A change in the server speed may result from server component failure, and/or other such similar events. The environment feature may also comprise a server expense such as, for example, a monetary expense to run the server. The environment feature may also comprise server resources, such as firewalls, securities, and/or the like. The environment feature may also comprise a server error rate. For example, a change in the server error rate may comprise a defined threshold of acceptable errors, such as a 5% error rate, and/or any other desired error rate. The environment feature may also comprise a server configuration. A change in the server configuration may comprise the addition or removal of a server, upgrades to server components, software installations, and/or the like.

In various embodiments, method 300 may comprise recalibrating the task (Step 350). In various embodiments, master data controller 150 (and/or local data controller 240, with brief reference to FIG. 2) may recalibrate the task in response to detecting the environment feature and/or the task feature. In that respect, the task may be recalibrated to efficiently execute the task, and/or to ensure efficiency of system 100 in regards to the execution of tasks, based at least in part on machine learning and predictive analysis to maximize efficiency and economics in system 100. Master data controller 150 (and/or local data controller 240, with brief reference to FIG. 2) may recalibrate the task by transferring the task, and/or a subtask of the task, to any other suitable server 130 (e.g., a server 130 having necessary logical communications with data sources on other servers 130 that are needed to execute the task). In that respect, transferring the task may recalibrate the task by locating a more efficient and/or suitable location for the task to process and/or execute. A suitable server 130 may comprise any server 130 that is capable of efficiently executing the task. For example, a task may require data located on other servers in a network environment 110 such as, for example, data located on servers 130-1Bn, 130-2n1, and 130-2B1. Master data controller 150 (and/or local data controller 240, with brief reference to FIG. 2) may locate a server 130 in system 100 that is in logical communication with servers 130-1Bn, 130-2n1, and 130-2B1, such that the task may execute.

In various embodiments, master data controller 150 (and/or local data controller 240), may also transfer the task, and/or subtask, to itself for execution. Master data controller 150 may receive and execute the task, and/or subtask, as needed. For example, master data controller 150 (and/or local data controller 240) may transfer the task to itself in response to an inability to locate a suitable server 130 to execute the task, a determination that master data controller 150 (and/or local data controller 240) is the most efficient and/or suitable location to execute the task, and/or the like. Master data controller 150 (and/or local data controller 240) may execute the task until a server 130 having required resources becomes available, until completion of the task, and/or the like. Master data controller 150 (and/or local data controller 240) may then transfer the task, and/or subtask, to a suitable server 130, when available.

In various embodiments, the system and method may include alerting a subscriber when their computer is offline. With brief reference to FIG. 1, system 100 may include generating customized information and alerting a remote subscriber that the information can be accessed from their computer. The alerts are generated by filtering received information, building information alerts and formatting the alerts into data blocks based upon subscriber preference information. The data blocks are transmitted to the subscriber's wireless device, which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email) to prevent a computer (e.g., servers 130) from being compromised, for example by being infected with a computer virus. The system may scan, via master data controller 150 for example, electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, system 100 may also address the problem of retaining control over customers during affiliate purchase transactions, using a system for co-marketing the “look and feel” of the host web page with the product-related content information of the advertising merchant's web page. System 100 can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

Phrases and terms similar to a “party” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, Facebook® message, Twitter® tweet and/or message, MMS, and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the herein particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system may also include a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS, etc.). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

As those skilled in the art will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure.

The blockchain structure may include a distributed database that maintains a growing list of data records. The blockchain may provide enhanced security because each block may hold individual transactions and the results of any blockchain executables. Each block may contain a timestamp and a link to a previous block. Blocks may be linked because each block may include the hash of the prior block in the blockchain. The linked blocks form a chain, with only one successor block allowed to link to one other predecessor block.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may then be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device, or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQTM (formerly MQSeries) by IBM®, Inc. (Armonk, N.Y.) is an example of a commercially available middleware product. An Enterprise Service Bus (“ESB”) application is another example of middleware.

Those skilled in the art will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. Cryptography and network security methods are well known in the art, and are covered in many standard texts.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is intended to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
monitoring, by a master data controller, a plurality of servers, wherein each server of the plurality of servers is located within an environment level of a network environment;
monitoring, by the master data controller, a task, wherein the task is located on a server;
detecting, by the master data controller, a change in a task feature, wherein the task feature is related to the task;
detecting, by the master data controller, a change in an environment feature, wherein the environment feature is related to at least one of the network environment, the environment level, or the servers; and
recalibrating, by the master data controller, the task in response to at least one of the change in the task feature or the change in the environment feature.

2. The method of claim 1, wherein the task comprises at least one subtask.

3. The method of claim 2, further comprising recalibrating, by the master data controller, at least one subtask in response to at least one of the change in the task feature or the change in the environment feature.

4. The method of claim 1, wherein the task feature comprises at least one of a task dependency, a task data source, or a subtask data source.

5. The method of claim 1, wherein the environment feature comprises at least one of a server usage, a server speed, a server resource, a server error rate, or a server configuration.

6. The method of claim 1, further comprising monitoring, by a local data controller in logical communication with the master data controller, the servers and the task.

7. The method of claim 6, further comprising detecting, by the local data controller, at least one of the change in the task feature or the change in the environment feature.

8. A system comprising:
a processor,
a tangible, non-transitory memory configured to communicate with the processor,
the tangible, non-transitory memory having instructions stored thereon that, in response to execution by the processor, cause the processor to perform operations comprising:
monitoring, by the processor, a plurality of servers, wherein each server of the plurality of servers is located within an environment level of a network environment;
monitoring, by the processor, a task, wherein the task is located on a server;
detecting, by the processor, a change in a task feature, wherein the task feature is related to the task;
detecting, the processor, a change in an environment feature, wherein the environment feature is related to at least one of the network environment, the environment level, or the servers; and
recalibrating, the processor, the task in response to at least one of the change in the task feature or the change in the environment feature.

9. The system of claim 8, wherein the task comprises at least one subtask.

10. The system of claim 9, further comprising, recalibrating, by the processor, at least one subtask in response to at least one of the change in the task feature or the change in the environment feature.

11. The system of claim 8, wherein the task feature comprises at least one of a task dependency, a task data source, or a subtask data source.

12. The system of claim 8, wherein the environment feature comprises at least one of a server usage, a server speed, a server resource, a server error rate, or a server configuration.

13. The system of claim 8, further comprising monitoring, by a local data controller in logical communication with the processor, the servers and the task.

14. The system of claim 13, further comprising detecting, by the local data controller, at least one of the change in the task feature or the change in the environment feature.

15. An article of manufacture including a non-transitory, tangible computer readable storage medium having instructions stored thereon that, in response to execution by a computer based system, cause the computer based system to perform operations comprising:
monitoring, by a master data controller, a plurality of servers, wherein each server of the plurality of servers is located within an environment level of a network environment;
monitoring, by the master data controller, a task, wherein the task is located on a server;
detecting, by the master data controller, a change in a task feature, wherein the task feature is related to the task;
detecting, by the master data controller, a change in an environment feature, wherein the environment feature is related to at least one of the network environment, the environment level, or the servers; and
recalibrating, by the master data controller, the task in response to at least one of the change in the task feature or the change in the environment feature.

16. The article of manufacture of claim 15, wherein the task comprises at least one subtask.

17. The article of manufacture of claim 16, further comprising, recalibrating, by the master data controller, at least one subtask in response to at least one of the change in the task feature or the change in the environment feature.

18. The article of manufacture of claim 15, wherein the task feature comprises at least one of a task dependency, a task data source, or a subtask data source, and wherein the environment feature comprises at least one of a server usage, a server speed, a server resource, a server error rate, or a server configuration.

19. The article of manufacture of claim 15, further comprising monitoring, by a local data controller in logical communication with the master data controller, the servers and the task.

20. The article of manufacture of claim 19, further comprising detecting, by the local data controller, at least one of the change in the task feature or the change in the environment feature.
